(19) United States
(12) Patent Application Publication
(10) Pub. No.: US 2010/0233456 A1
(43) Pub. Date: Sep. 16, 2010

(54) LIGHT-STABILIZED POLYPROPYLENE

(75) Inventors: Yoshiaki Oobayashi, Kanagawa (JP); Tsuyoshi Watanabe, Chiba (JP); Takeshi Maruyama, Valley Park (SG)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Chuo-ku, Tokyo (JP)

(21) Appl. No.: 12/679,129

(22) PCT Filed: Sep. 19, 2008
(86) PCT No.: PCT/JP2008/067587

§ 371 Date: Mar. 19, 2010

(30) Foreign Application Priority Data
Sep. 21, 2007 (JP) 2007-245032

(51) Int. Cl. C08K 5/3435; B32B 27/20

(52) U.S. Cl. 428/220; 524/99

(57) ABSTRACT

There are provided a polypropylene resin composition having a melt flow rate of 5 to 200 g/10 minutes measured at 230° C., and a molded article comprising the same, wherein the polypropylene resin composition does not easily emit a volatile organic compound contained therein, and is superior in its heat stability, light stability and molding processability, and comprises 100 parts by weight of a propylene block copolymer (A), and 0.05 to 5 parts by weight of a hindered amine light stabilizer (B) having (a) a 2,2,6,6-tetramethylpiperidyl group, (b) an acid dissociation constant (pKa) of less than 8, and (c) a rate of decrease in its weight of less than 10% by heating in a nitrogen gas from 25° C. to 300° C. at a temperature increasing rate of 10° C./minute.

### TECHNICAL FIELD

The present invention relates to a light-stabilized polypropylene resin composition and a molded article comprising the polypropylene resin composition. In more detail, the present invention relates to a polypropylene resin composition, which does not easily emit an organic compound contained therein, although the organic compound is intrinsically volatile, and which is excellent in its heat stability, light stability and molding processability, and relates to a molded article comprising the polypropylene resin composition.

### BACKGROUND ART

Polypropylene resins are applied to widespread uses such as various containers, food packaging materials, caps for containers such as bottles, stationary products, convenience goods, fibers for carpets or sofas, car interior or exterior materials, home electronics materials, and building materials such as interior materials for buildings or houses, because polypropylene resins are typical resins among thermoplastic resins, which are cheap, lightweight and excellent in their characteristics such as molding processability, mechanical characteristics and heat resistance. Meanwhile, when using polypropylene resins indoors or outdoors, those resins may remarkably be destroyed in their excellent quality (for example, appearance and mechanical properties) by factors such as oxygen, ultraviolet ray and heat. Particularly, it is an important problem to maintain quality of car interior or exterior materials for a long time. It has been performed heretofore to blend antioxidants or light stabilizers with polypropylene resins in order to improve their long-term stability. However, those polypropylene resins are not satisfactory yet in their quality stability, and there have been strongly requested materials further maintaining their properties and appearance for a long time.

For example, WO94/12544 discloses maleic imide-α-olefin copolymers having an average molecular weight of 1,000 to 50,000, and suitable for a light stabilizer or a stabilizer of organic materials, especially plastics or coating materials, and disclose a production method of those copolymers.

Also, JP 10-77462A discloses a stabilizer mixture containing a specific maleic imide-α-olefin copolymer, a sterically-hindered amine, a magnesium compound, a zinc compound and a ultraviolet absorber and/or pigment, and discloses a polyolefin stabilized by the stabilizer mixture.

JP 2003-76A discloses an agricultural polyolefin resin film obtained by coating a resin composition on a specific polyolefin resin, wherein the resin composition contains 0.02 to 1% by weight of a triazine ultraviolet absorber, and 0.1 to 5% by weight of a hindered amine light stabilizer having molecular weight of 2,000 or more.

WO 02/92684 discloses a stabilized thermoplastic resin composition, and a stabilized molded article, sheet and fiber, and discloses production processes of those molded goods, wherein the stabilized thermoplastic resin composition contains one or more kinds of polyolefins produced by use of one or more kinds of metallocene catalysts, and one or more kinds of stabilizers selected from sterically-hindered amines having a specific structure.

JP 2006-169273A discloses a polypropylene resin composition, and a fiber and nonwoven cloth by use thereof, wherein the polypropylene resin composition contains 100 parts by weight of a polypropylene resin composition, 0.05 to 0.5 part by weight of a hindered amine light stabilizer, and 0.05 to 0.5 part by weight of an ultraviolet absorber, and the polypropylene resin composition is obtained by melt-blending 85 to 95% by weight of a polypropylene resin, 3 to 9% by weight of an ethylene-vinyl acetate (EVA), and 2 to 6% by weight of a polyetheresteramide compound.

Meanwhile, out of concern for a sick house problem (indoor air contamination) caused by building materials such as interior materials for buildings or houses, resin materials used are recently requested to reduce their volatile organic compounds (hereinafter, abbreviated to VOC), which are reported to be substances responsible for a sick house problem. Among those volatile organic compounds, precautionary measures are investigated with respect to thirteen kinds of VOCs including formaldehyde. On the other hand, the sick house problem is targeted to not only building materials but also other materials such as car interior materials, and there is desired use of resin materials containing a small amount of VOC. Namely, as resins applied to materials such as car interior materials, there are desired polypropylene resins which emit only a slight amount of VOC, and are excellent in their light stability in a long-term use.

### DISCLOSURE OF INVENTION

An object of the present invention is to obtain a polypropylene resin molded article which is suppressed in its emission of VOC, and furthermore is excellent in its impact resistance and light stability, and is to obtain a polypropylene resin composition, which is kind to environment and suitable as a material for such a molded article, and is suppressed in its emission of VOC, and furthermore is excellent in its heat stability, light stability and impact resistance and also molding processability.

The present invention provides a polypropylene resin composition comprising:
100 parts by weight of a propylene block copolymer (A) having a melt flow rate of 5 to 200 g/10 minutes measured at 230° C. under a load of 2.16 kgf; and
0.01 to 5 parts by weight of a hindered amine light stabilizer (B) satisfying the following requirements (a), (b) and (c);
requirement (a) is that the hindered amine light stabilizer (B) has a 2,2,6,6-tetramethylpiperidyl group represented by the general formula (I), wherein X is linked to a carbon atom, an oxygen atom or a nitrogen atom,

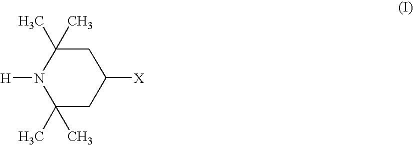

requirement (b) is that the hindered amine light stabilizer (B) has an acid dissociation constant (pKa) of less than 8, and
requirement (c) is that the hindered amine light stabilizer (B) shows a rate of decrease in its weight of less than 10% by heating in a nitrogen gas from 25° C. to 300° C. at a temperature increasing rate of 10° C./minute.

### BRIEF DESCRIPTION OF THE DRAWINGS

FIG. 1 shows a shape of a flow channel of an elliptic spiral mold used in Example.

FIG. 2 roughly shows a shape of an iron heavy bob used for measuring falling ball impact strength in Example, wherein the numerical numbers show length (unit: mm).

### BEST MODE FOR CARRYING OUT THE INVENTION

The propylene block copolymer (A) used in the present invention comprises polymer components (I) and (II). The resin composition of the present invention contains one or more kinds of the propylene block copolymers.

The polymer component (I) is a propylene homopolymer component, or a propylene copolymer component mainly containing propylene-derived units. When the polymer component (I) is a propylene copolymer component, the polymer component (I) comprises propylene-derived units, and units derived from one or more kinds of comonomers selected from the group consisting of ethylene and α-olefins having 4 to 12 carbon atoms.

When the above polymer component (I) is such a propylene copolymer component, the polymer component (I) contains 0.01 to 30% by weight of the units derived from one or more kinds of comonomers selected from the group consisting of ethylene and α-olefins having 4 to 12 carbon atoms, the total of the polymer component (I) being 100% by weight.

Examples of the α-olefins having 4 to 12 carbon atoms making the polymer component (I) are 1-butene, 1-pentene, 1-hexene, 4-methyl-1-pentene, 1-octene, and 1-decene. Among them, preferred is 1-butene, 1-hexene or 1-octene.

Examples of the propylene copolymer component as the polymer component (I) are a propylene-ethylene copolymer component, a propylene-1-butene copolymer component, a propylene-1-hexene copolymer component, a propylene-1-octene copolymer component, a propylene-ethylene-1-butene copolymer component, a propylene-ethylene-1-hexene copolymer component, and a propylene-ethylene-1-octene copolymer component.

The above polymer component (II) is a propylene copolymer component containing propylene-derived units, and units derived from one or more kinds of comonomers selected from the group consisting of ethylene and α-olefins having 4 to 12 carbon atoms.

The above polymer component (II) contains 1 to 80% by weight of the units derived from one or more kinds of comonomers selected from the group consisting of ethylene and α-olefins having 4 to 12 carbon atoms, preferably 20 to 70% by weight thereof, and more preferably 30 to 60% by weight thereof, the total of the polymer component (II) being 100% by weight.

Examples of the α-olefins having 4 to 12 carbon atoms making the polymer component (II) are 1-butene, 1-pentene, 1-hexene, 4-methyl-1-pentene, 1-octene, and 1-decene. Among them, preferred is 1-butene, 1-hexene or 1-octene.

Examples of the polymer component (II) are a propylene-ethylene copolymer component, a propylene-1-butene copolymer component, a propylene-1-hexene copolymer component, a propylene-ethylene-1-butene copolymer component, and a propylene-ethylene-1-hexene copolymer component.

Examples of the propylene block copolymer (A) are a (propylene)-(propylene-ethylene) copolymer, a (propylene)-(propylene-ethylene-1-butene) copolymer, a (propylene)-(propylene-ethylene-1-hexene) copolymer, a (propylene)-(propylene-1-butene) copolymer, a (propylene)-(propylene-1-hexene) copolymer, a (propylene-ethylene)-(propylene-ethylene) copolymer, a (propylene-ethylene)-(propylene-ethylene-1-butene) copolymer, a (propylene-ethylene)-(propylene-ethylene-1-hexene) copolymer, a (propylene-ethylene)-(propylene-1-butene) copolymer, a (propylene-ethylene)-(propylene-1-hexene) copolymer, a (propylene-1-butene)-(propylene-ethylene) copolymer, a (propylene-1-butene)-(propylene-ethylene-1-butene) copolymer, a (propylene-1-butene)-(propylene-ethylene-1-hexene) copolymer, a (propylene-1-butene)-(propylene-1-butene) copolymer, and a (propylene-1-butene)-(propylene-1-hexene) copolymer.

The propylene block copolymer (A) contains the polymer component (II) in an amount of 1 to 70% by weight, preferably 5 to 50% by weight, more preferably 10 to 50% by weight, and further preferably 10 to 40% by weight, the total of the propylene block copolymer (A) being 100% by weight.

The propylene block copolymer (A) comprises preferably the polymer component (I) of a propylene homopolymer component, and the polymer component (II) of a propylene copolymer component, which contains units derived from one or more kinds of comonomers selected from the group consisting of ethylene and α-olefins having 4 to 12 carbon atoms, and units derived from propylene.

The propylene block copolymer (A) comprises more preferably the polymer component (I) of a propylene homopolymer component, and 5 to 75% by weight of the polymer component (II) of a propylene-ethylene copolymer component, which contains 20 to 70% by weight of units derived from ethylene.

The propylene block copolymer (A) has a melt flow rate (hereinafter, referred to as MFR) of 5 to 200 g/10 minutes measured at 230° C. under a load of 2.16 kgf. It is preferably 10 to 200 g/10 minutes, more preferably 20 to 100 g/10 minutes, and further preferably 20 to 70 g/10 minutes, from a viewpoint of molding processability of the polypropylene resin composition, and impact resistance of molded articles comprising the resin composition.

The polymer component (I) has an intrinsic viscosity [η]_{I} of 0.1 to 5 dl/g, preferably 0.3 to 3 d/g, and more preferably 0.5 to 1.5 d/g, measured at 135° C. in Tetraline. When the intrinsic viscosity [η]_{I} is larger than 5 dl/g, the polypropylene resin composition may be degraded in its mechanical properties and molding processability. When the intrinsic viscosity [η]_{I} is smaller than 0.1 dl/g, the polypropylene resin composition may be insufficient in its molding processability, or may emit a large amount of VOC.

Also, the polymer component (II) has an intrinsic viscosity [η]_{II} of 1 to 20 dl/g, preferably 1 to 15 d/g, more preferably 2 to 10 d/g, and further preferably 3 to 7 dl/g, measured at 135° C. in Tetraline. When the intrinsic viscosity [η]_{II} is larger than 20 dl/g, the polypropylene resin composition may be degraded in its mechanical properties and molding processability. When the intrinsic viscosity [η]_{II} is smaller than 1 dl/g, the polypropylene resin composition may be insufficient in its molding processability.

Further, the ratio of the intrinsic viscosity [η]_{II} of the polymer component (II) to the intrinsic viscosity [η]_{I} of the polymer component (I) is preferably 1 to 20, more preferably 2 to 10, and further preferably 2 to 8, from a viewpoint of mechanical properties and molding processability of the polypropylene resin composition.

The intrinsic viscosity [η] (dl/g) is measured at 135° C. using Tetraline as a solvent, according to the following method:
measuring reduced viscosities of three solutions having concentrations of 0.1 g/dl, 0.2 g/dl and 0.5 g/dl, respectively, using an Ubbellohde viscometer; and
calculating an intrinsic viscosity according to a method described in “Kobunshi yoeki, Kobunshi jikkengaku 11” (published by Kyoritsu Shuppan Co. Ltd. in 1982), page 491, namely, by plotting those reduced viscosities for those concentrations, and then extrapolating the concentration to zero.
   Samples for the above solutions are the propylene block copolymer (A), which is polymer powders taken out of a polymerization reactor, or pellets comprising the polymer powders. Samples of the polymer component (I) are polymer powders taken out of a polymerization reactor in the first step.

Also, when the propylene block copolymer (A) is produced according to a process comprising the steps of firstly polymerizing the polymer component (I), and secondly polymerizing the polymer component (II), contents of the polymer components (I) and (II) and intrinsic viscosities ([η]_{Total}, [η]_{I} and [η]_{II}) are measured and calculated, as follows, wherein the [η]_{Total} is an intrinsic viscosity of the propylene block copolymer (A).

The intrinsic viscosity of the polymer component (II), [η]_{II}, is calculated from the following formula:

[η]_{II}=([η]_{Total}−[η]_{I}×X_{I})/X_{II}

wherein [η]_{Total} (dl/g) is an intrinsic viscosity of the propylene block copolymer (A) finally obtained; [η]_{I} (dl/g) is an intrinsic viscosity of polymer powders (polymer component (I)) taken out after the first polymerization step; X_{I} is a ratio by weight of the polymer component (I) produced in the first polymerization step; and X_{II} is a ratio by weight of the polymer component (II) produced in the second polymerization step; and X_{I} and X_{II} are obtained from a material balance in the polymerization.

The polymer component (I) contained in the propylene block copolymer (A) has an isotactic pentad fraction (mmmm fraction) of 0.96 or larger, more preferably 0.97 or larger, and further preferably 0.98 or larger, measured by ¹³C-NMR, in order to obtain the propylene block copolymer (A) having high crystallinity and rigidity.

The isotactic pentad fraction is a fraction of propylene monomer units existing in the center of a continuous meso-bonding chain of five propylene monomer units, in relation to a pentad unit in a polypropylene molecule, and is measured by a ¹³C-NMR method disclosed in Macromolecules, 6, 925 (1973) published by A. Zambelli et al., wherein ¹³C-NMR absorption peaks are assigned based on Macromolecules, 8, 687 (1975).

Also, when the polymer component (I) in the propylene block copolymer (A) is a propylene copolymer component containing main units derived from propylene, the polymer component (I) contains a soluble part in xylene at 20° C. in an amount of preferably less than 1.0% by weight, more preferably 0.8% by weight or less, and further preferably 0.5% by weight or less, from a viewpoint of crystallinity and tensile strength of the propylene block copolymer, the soluble part in xylene at 20° C. being hereinafter referred to as CXS (I).

The propylene block copolymer (A) comprises preferably the polymer component (I) of a homopolymer component of propylene, and the polymer component (II), which contains units derived from one or more kinds of comonomers selected from the group consisting of ethylene and α-olefins having 4 to 12 carbon atoms, and units derived from propylene.

The propylene block copolymer (A) comprises more preferably the polymer component (I) of a homopolymer component of propylene, and 5 to 75% by weight of the polymer component (II) of a propylene-ethylene copolymer component, which contains 20 to 70% by weight of units derived from ethylene.

From a viewpoint of impact resistance, molding processability and an emission amount of VOC of the propylene block copolymer (A), the propylene block copolymer (A) satisfies particularly preferably the following requirements (e), (f), (g) and (h):
requirement (e) is that the polymer component (I) in the propylene block copolymer (A) is a propylene polymer having an intrinsic viscosity [η]_{I} of 0.1 to 1.5 dl/g, measured at 135° C. in Tetraline, and that the polymer component (II) therein is a propylene copolymer, which is obtained by copolymerizing propylene with one or more kinds of monomers selected from the group consisting of ethylene and α-olefins having 4 to 12 carbon atoms, and has an intrinsic viscosity [η]_{II} of 1 to 20 dl/g, measured at 135° C. in Tetraline;
requirement (f) is that the polymer component (I) has an isotactic pentad fraction (mmmm fraction) of 0.98 or larger, measured by ¹³C-NMR;
requirement (g) is that the polymer component (II) contains 1 to 80% by weight of units derived from one or more kinds of monomers selected from the group consisting of ethylene and α-olefins having 4 to 12 carbon atoms, the total of the polymer component (II) being 100% by weight; and
requirement (h) is that the propylene block copolymer (A) contains 5 to 70% by weight of the polymer component (II), the total of the propylene block copolymer (A) being 100% by weight.

The propylene block copolymer (A) can be produced using a polymerization catalyst known in the art, according to a polymerization method known in the art.

Examples of the polymerization catalyst are Ziegler type catalyst systems; Ziegler-Natta type catalyst systems; catalyst systems containing a cyclopentadienyl ring-carrying compound of a transition metal of the group 4 of the periodic table and an alkylaluminoxane; catalyst systems containing a cyclopentadienyl ring-carrying compound of a transition metal of the group 4 of the periodic table, a compound forming an ionic complex by a reaction with the cyclopentadienyl ring-carrying compound of a transition metal of the group 4 of the periodic table, and an organoaluminum compound; and catalyst systems obtained by treating those catalyst components with particles (for example, inorganic particles). There may also be used pre-polymerized catalysts prepared by pre-polymerizing ethylene or an α-olefin in the presence of the above catalyst systems.

The above catalyst systems are disclosed in documents such as JP 61-218606A, JP 5-194685A, JP 7-216017A, JP 10-212319A, JP 2004-182981A and JP 9-316147A.

Examples of the polymerization method are liquid phase (bulk) polymerization, solution polymerization, slurry polymerization, and gas phase polymerization. The bulk polymerization is carried out in an olefin medium liquid at a polymerization temperature; the solution or slurry polymerization is carried out in an inert hydrocarbon solvent such as propane, butane, isobutene, pentane, hexane, heptane and octane; and the gas phase polymerization is carried out by polymerizing a gaseous monomer in a medium of the gaseous monomer. Those polymerization methods are a batch-wise or continuous method, and any plural methods thereof may be combined with one another. The propylene block copolymer (A) is produced preferably according to a continuous gas phase polymerization method, or a liquid phase-gas phase polymerization method, wherein a liquid phase polymerization method and a gas phase polymerization method are carried out sequentially, from an industrial and economical point of view, and in order to suppress an emission amount of VOC by decreasing VOC remaining in the propylene block copolymer (A), using inert hydrocarbon solvents as little as possible.

Also, the propylene block copolymer (A) is produced according to a multi-step production method containing two or more steps, and is produced preferably according to a method containing the first step of producing the polymer component (I), and the second step of producing the polymer component (II).

The multi-step production method of the propylene block copolymer (A) is disclosed in documents such as JP 5-194685A and JP 2002-12719A.

Various conditions in the polymerization step (for example, polymerization temperature, polymerization pressure, monomer concentration, catalyst input, and polymerization time) may be suitably determined according to a structure and characteristics of target propylene block copolymers, for example, content and intrinsic viscosities [η]_{I} and [η]_{II} of the polymer components (I) and (II), and content of units derived from one or more kinds of comonomers, which are copolymerized with propylene, and selected from the group consisting of ethylene and α-olefins having 4 to 12 carbon atoms.

In a production of the propylene block copolymer (A), the propylene block copolymer (A) may be dried at a temperature lower than its melting temperature, in order to remove a solvent remaining in the propylene block copolymer (A), and ultra-low molecular weight oligomers by-produced in a production of the propylene block copolymer (A). Such a drying treatment is effective for decreasing an emission amount of VOC. The propylene block copolymer (A) for drying is not particularly limited in its shape, and may be powder or pellets. Drying methods are exemplified by documents such as JP 55-75410A and JP 2-80433A.

The polypropylene resin composition of the present invention has a melt flow rate (MFR) of 5 to 200 g/10 minutes, preferably 10 to 200 g/10 minutes, more preferably 10 to 100 g/10 minutes, and further preferably 15 to 70 g/10 minutes, measured at 230° C. under a load of 2.16 kgf, in order to suppress an emission of VOC and improve molding processability.

When starting materials are melt-kneaded to prepare the polypropylene resin composition of the present invention, organic peroxides may be blended in the melt-kneading step to regulate MFR of the obtained polypropylene resin composition.

Examples of the organic peroxides are alkyl peroxides, diacyl peroxides, peroxy-esters, and peroxy-carbonates. Examples of the alkyl peroxides are dicumyl peroxide, di-t-butyl peroxide, t-butylcumyl peroxide, 2,5-dimethyl-2,5-di(t-butylperoxy)hexane, 2,5-dimethyl-2,5-di(t-butylperoxy)hexyne-3,1,3-bis(t-butyl peroxyisopropyl)benzene, and 3,6,9-triethyl-3,6,9-trimethyl-1,4,7-triperoxonane.

Examples of the diacyl peroxides are benzoyl peroxide, lauroyl peroxide and decanoyl peroxide. Examples of the peroxy-esters are 1,1,3,3-tetramethylbutyl peroxyneodecanoate, α-cumyl peroxyneodecanoate, t-butyl peroxyneodecanoate, t-butyl peroxyneoheptanoate, t-butyl peroxypivalate, t-hexyl peroxypivalate, 1,1,3,3-tetramethylbutyl peroxy-2-ethylhexanoate, t-amyl peroxy-2-ethylhexanoate, t-butyl peroxy-2-ethylhexanoate, t-butyl peroxyisobutylate, di-t-butyl peroxyhexahydroterephthalate, t-amyl peroxy-3,5,5-trimethylhexanoate, t-butyl peroxy-3,5,5-trimethylhexanoate, t-butyl peroxyacetate, t-butyl peroxybenzoate, and di-t-butyl peroxytrimethyladipate.

Examples of the peroxy-carbonates are di-3-methoxybutyl peroxydicarbonate, di(2-ethylhexyl) peroxydicarbonate, diisopropyl peroxycarbonate, t-butyl peroxyisopropylcarbonate, di(4-t-butylcyclohexyl) peroxydicarbonate, dicetyl peroxydicarbonate, and dimyristyl peroxydicarbonate.

Organic peroxides are preferably alkyl peroxides, and particularly preferably 2,5-dimethyl-2,5-di(t-butylperoxy)hexane, 1,3-bis(t-butyl peroxyisopropyl)benzene, or 3,6,9-triethyl-3,6,9-trimethyl-1,4,7-triperoxonane.

Organic peroxides are used in an amount of generally 0.0001 to 0.5 part by weight, preferably 0.0005 to 0.3 part by weight, and more preferably 0.001 to 0.1 part by weight, per 100 parts by weight of the propylene block copolymer (A). However, it is preferable to control the blending amount in accordance with an object, because too much blending amount thereof slightly improves molding processability of the polypropylene resin composition, but may increase an emission amount of VOC of the polypropylene resin composition.

Organic peroxides may be used as a master batch, which is prepared by impregnating powder of the propylene block copolymer (A) with organic peroxides. The powder is not particularly limited in its weight average particle diameter, which is generally 100 μm to 2,000 μm, from a viewpoint of dispersibility of organic peroxides in the propylene block copolymer (A) in a melt blending. Organic peroxides are not particularly limited in an impregnation amount, which is generally 1 to 50% by weight, and preferably 5 to 20% by weight, from a viewpoint of ease in handling.

The hindered amine light stabilizer (B) is a compound satisfying the following requirements (a), (b) and (c):
requirement (a) is that the hindered amine light stabilizer (B) has a 2,2,6,6-tetramethylpiperidyl group represented by the general formula (I), wherein X is linked to a carbon atom, an oxygen atom or a nitrogen atom,

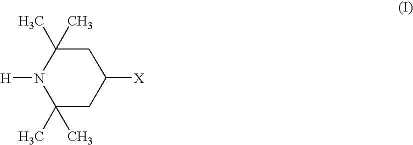

requirement (b) is that the hindered amine light stabilizer (B) has an acid dissociation constant (pKa) of less than 8, and
requirement (c) is that the hindered amine light stabilizer (B) shows a rate of decrease in its weight of less than 10% by heating in a nitrogen gas from 25° C. to 300° C. at a temperature increasing rate of 10° C./minute.
   Further, the hindered amine light stabilizer (B) preferably satisfies the requirement (d) that it has a molecular weight of 1,000 or more.

Regarding the requirement (a), X is linked preferably to an oxygen atom or a nitrogen atom, and further preferably to a nitrogen atom, in a compound having a 2,2,6,6-tetramethylpiperidyl group represented by the general formula (I), from a viewpoint of light stability.

Regarding the requirement (b), pKa is preferably less than 8, and further preferably 7 or less, from a viewpoint of light stability. The pKa value is an index showing an inherent nature of the compound having a 2,2,6,6-tetramethylpiperidyl group represented by the general formula (I), and is measured by a titration method known in the art, which is a measurement method of an acid dissociation constant based on a Brøsted's definition.

Regarding the requirement (c), the rate of decrease in weight by heating under the above conditions is preferably less than 5%, and further preferably less than 3%, from a viewpoint of an emission amount of VOC and light stability. A rate of decrease in weight of the hindered amine light stabilizer (B) is measured using a thermo gravimetry differential thermal analyzer (hereinafter, referred to as TG/DTA). Specifically, the hindered amine light stabilizer (B) is heated from 25° C. to 300° C. at a rate of 10° C./minute in a nitrogen gas atmosphere, which gas is flowed at a constant rate of 100 mL/minute, thereby measuring the rate (percentage) of a weight loss to the original weight with a thermobalance.

Regarding the requirement (d), the hindered amine light stabilizer (B) has a molecular weight of preferably 1,500 or larger, and more preferably 2,000 or larger, from a viewpoint of an emission amount of VOC and light stability.

Among them, there are used preferably light stabilizers comprising a copolymer containing a maleic imide derivative component represented by the general formula (II):

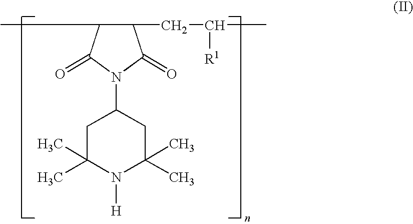

wherein R¹ is an alkyl group having 10 to 30 carbon atoms; and n is an integer of larger than 1.

In the general formula (II), R¹ is preferably an alkyl group having 14 to 28 carbon atoms, more preferably an alkyl group having 16 to 26 carbon atoms, and further preferably an alkyl group having 18 to 22 carbon atoms. The alkyl group may be a linear or cyclic alkyl group, and preferably a linear alkyl group.

The hindered amine light stabilizer (B) is blended in an amount of 0.05 to 5 parts by weight per 100 parts by weight of the propylene block copolymer (A), and in an amount of preferably 0.05 to 1 part by weight, and more preferably 0.05 to 0.3 part by weight. When the amount is smaller than the above range, an improvement effect of light stability is not sufficient. When the amount is larger than the above range, a molded article may be disfeatured in its appearance, or a mold may be dirtied in injection molding, and therefore it is preferable to control a blending amount in accordance with an object.

The hindered amine light stabilizer (B) is not particularly limited in its blending timing.

The hindered amine light stabilizer (B) is used in a form of, for example, liquid, powder, granule or pellet. The hindered amine light stabilizer (B) is also used in a form of a composition, which is previously obtained by blending the stabilizer (B) in high concentration with a component such as resins, resin additives and pigments.

The polypropylene resin composition of the present invention can be produced according to a method comprising the steps of, for example, melt-blending the propylene block copolymer (A) with additives at 180° C. or higher, thereby obtaining a melt-blend, and filtering the melt-blend. The melt-blending temperature is preferably 180° C. or higher and lower than 300° C., and further preferably 180° C. or higher and lower than 270° C., in order to suppress an emission amount of VOC of molded articles comprising the polypropylene resin composition.

Also, the polypropylene resin composition of the present invention may contain additives known in the art, such as neutralizing agents, antioxidants, process stabilizers, ultraviolet absorbers, nucleating agents, transparency nucleus agents, antistatic agents, lubricants, process auxiliary agents, metal soaps, coloring agents (pigments such as carbon black and titanium oxide), foaming agents, antibacterial agents, plasticizers, flame retardants, cross-linking agents, cross-linking co-agents, high brightness agents, and fillers. Those additives are used alone, or in combination of two or more thereof.

Among them, antioxidants are preferably used. In the present invention, use of antioxidants is highly effective in order to suppress increase of an emission amount of VOC in the polypropylene resin composition, or in order to improve molding processability or a long-term light stability. Examples of applicable antioxidants are phenol-type antioxidants, phosphorus-type antioxidants, sulfur-type antioxidants, and hydroxylamine-type antioxidants.

Among them, preferred are phenol-type antioxidants or phosphorus-type antioxidants, and further preferred are combinations of phenol-type antioxidants with phosphorus-type antioxidants.

Phenol-type antioxidants have molecular weight of preferably 300 or more. Examples thereof are tetrakis[methylene-3-(3′,5′-di-t-butyl-4-hydroxyphenyl) propionate]methane, octadecyl-3-(3,5-di-t-butyl-4-hydroxyphenyl)propionate, 3,9-bis[2-{3-(3-t-butyl-4-hydroxy-5-methylphenyl) propionyloxy}-1,1-dimethylethyl]-2,4,8,10-tetraoxaspiro [5.5]undecane, triethyleneglycol-N-bis-3-(3-t-butyl-5-methyl-4-hydroxyphenyl)propionate, 1,6-hexanediolbis[3-(3,5-di-t-butyl-4-hydroxyphenyl) propionate], 2,2-thio-diethylenebis[3-(3,5-di-t-butyl-4-hydroxyphenyl) propionate], 1,3,5-tris[3(3,5-di-t-butyl-4-hydroxyphenyl)propionyloxy]ethylisocyanate, 1,3,5-trimethyl-2,4,6-tris(3,5-di-t-butyl-4-hydroxybenzyl)benzene, tris(3,5-di-t-butyl-4-hydroxybenzyl)isocyanurate, and 1,3,5-tris(4-t-butyl-3-hydroxy-2,6-dimethylbenzyl) isocyanurate.

Among them, there are used phenol-type antioxidants having molecular weight of preferably 300 or more, in order to improve molding processability and heat aging-resistance of the polypropylene resin composition. Examples of those antioxidants are tetrakis[methylene-3-(3′,5′-di-t-butyl-4-hydroxyphenyl) propionate]methane, octadecyl-3-(3,5-di-t-butyl-4-hydroxyphenyl)propionate, 3,9-bis[2-{3-(3-t-butyl-4-hydroxy-5-methylphenyl) propionyloxy}-1,1-dimethylethyl]-2,4,8,10-tetraoxaspiro [5.5]undecane, triethyleneglycol-N-bis-3-(3-t-butyl-5-methyl-4-hydroxyphenyl)propionate, 1,6-hexanediolbis[3-(3,5-di-t-butyl-4-hydroxyphenyl) propionate], and 2,2-thio-diethylenebis[3-(3,5-di-t-butyl-4-hydroxyphenyl) propionate].

In order to obtain resin compositions having an excellent hue stability, there is preferably used 3,9-bis[2-{3-(3-t-butyl-4-hydroxy-5-methylphenyl) propionyloxy}-1,1-dimethylethyl]-2,4,8,10-tetraoxaspiro [5.5]undecane.

Phenol-type antioxidants are arbitrarily determined in their blending amount, which is usually 0.01 to 1 part by weight, preferably 0.01 to 0.5 part by weight, and further preferably 0.05 to 0.3 part by weight, per 100 parts by weight of the propylene block copolymer (A).

Examples of the phosphorus-type antioxidants are tris(nonylphenyl) phosphite, tris(2,4-di-t-butylphenyl) phosphite, distearylpentaerythritol diphosphite, bis(2,4-di-t-butylphenyl)pentaerythritol diphosphite, bis(2,4-di-t-butyl-6-methylphenyl)pentaerythritol diphosphite, bis(2,6-di-t-butyl-4-methylphenyl)pentaerythritol diphosphite, bis(2,4-dicumylphenyl)pentaerythritol diphosphite, tetrakis(2,4-di-t-butylphenyl)-4,4′-diphenylene diphosphonite, 2,2′-methylenebis(4,6-di-t-butylphenyl) 2-ethylhexylphosphite, 2,2′-ethylidenebis(4,6-di-t-butylphenyl) fluorophosphite, bis(2,4-di-t-butyl-6-methylphenyl)ethyl phosphite, 2-(2,4,6-tri-t-butylphenyl)-5-ethyl-5-butyl-1,3,2-oxaphospholinane, 2,2′,2″-nitrilo[triethyl-tris(3,3′,5,5′-tetra-t-butyl-1,1′-biphenyl-2,2′-diyl)]phosphite, and 6-[3-(3-methyl-4-hydroxy-5-t-butylphenyl)propoxy]-2,4,8,10-tetra-t-butyl-dibenz[d,f][1,3,2]dioxaphosphepine.

In order to improve molding processability and heat stability of the polypropylene resin composition, there are preferably used phosphorus-type antioxidants having molecular weight of 300 or more. Examples thereof are tris(2,4-di-t-butylphenyl) phosphite, bis(2,4-di-t-butylphenyl)pentaerythritol diphosphite, bis(2,4-di-t-butyl-6-methylphenyl)pentaerythritol diphosphite, bis(2,6-di-t-butyl-4-methylphenyl)pentaerythritol diphosphite, and 6-[3-(3-methyl-4-hydroxy-5-t-butylphenyl)propoxy]-2,4,8,10-tetra-t-butyl-dibenz[d,f][1,3,2]dioxaphosphepine.

Phosphorus-type antioxidants are blended in an amount of generally 0.01 to 1 part by weight, preferably 0.01 to 0.5 part by weight, and further preferably 0.05 to 0.3 part by weight, per 100 parts by weight of the propylene block copolymer (A).

The polypropylene resin composition of the present invention contains 0.01 to 1 part by weight of phenol-type antioxidants and/or phosphorus-type antioxidants, both having molecular weight of 300 or more, per 100 parts by weight of the propylene block copolymer (A), which is one of preferable embodiments.

Nucleating agents preferably used in the present invention are inorganic or organic nucleating agents. Examples of the inorganic nucleating agents are talc, clay, and calcium carbonate. When using inorganic nucleating agents, those agents may be previously treated by silane coupling agents, aliphatic acids, acidic materials or basic materials, in order to prevent aggregation of particles, and improve dispersibility thereof in the propylene block copolymer (A).

Examples of the organic nucleating agents known in the art are metal salts of aromatic carboxylic acids; metal salts of dicarboxylic acids, whose two carboxyl groups are linked to each of two carbon atoms forming a ring of a cyclic saturated or unsaturated hydrocarbon, as disclosed in WO02/79312 and WO02/77092; metal salts of aromatic phosphoric acids; dibenzylidene sorbitols; and polymer-type nucleating agents (poly-3-methylbutene-1, polycyclopentene and polyvinylcyclohexane).

Examples of the metal salts of aromatic carboxylic acids are metal salts of benzoic acid substituted by a cyclic hydrocarbyl group such as a cyclohexyl group. Examples of the metal atom of metal salts of aromatic carboxylic acids are metal atoms of the groups 1, 2, 4, 13 and 14 of the periodic table of elements, and preferred are metal atoms of the groups 1, 2 and 13.

Specific examples of the metal atom of the group 1 are lithium, sodium and potassium; those of the group 2 are magnesium, calcium, strontium and barium; those of the group 4 are titanium and zirconium; those of the group 13 are aluminum and gallium; and those of the group 14 are germanium, tin and lead.

The metal salts of aromatic carboxylic acids are preferably lithium benzoate, potassium benzoate, sodium benzoate, aluminum benzoate, aluminum hydroxyl-di(para-t-butylbenzoate), sodium cyclohexanecarboxylate, or sodium cyclopentanecarboxylate, and more preferably sodium benzoate or aluminum hydroxyl-di(para-t-butylbenzoate).

The metal salts of dicarboxylic acids, whose two carboxyl groups are linked to each of two carbon atoms forming a ring of a cyclic saturated or unsaturated hydrocarbon, as disclosed in WO02/79312 and WO02/77092, are, for example, metal salts of hexahydrophthalic acid, and preferably disodium=(1R,2R,3S,4S)-bicyclo[2.2.1]heptane-2,3-dicarboxylate (Hyperfrom [registered trade name] HPN-68L, manufactured by Milliken Japan K.K., represented by the following structural formula.

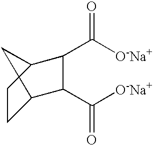

Examples of the metal salts of aromatic phosphoric acids are metal salts of aromatic phosphoric acid esters substituted with a hydrocarbyl group having 1 to 12 carbon atoms. Examples of the metal atom linked to the aromatic phosphoric acid groups are metal atoms of the groups 1, 2, 4, 13 and 14 of the periodic table of elements, and preferred are metal atoms of the groups 1 and 2.

Specific examples of the metal atom of the group 1 are lithium, sodium and potassium; those of the group 2 are magnesium, calcium, strontium and barium; those of the group 4 are titanium and zirconium; those of the group 13 are aluminum and gallium; and those of the group 14 are germanium, tin and lead.

Preferable examples of the metal salts of aromatic phosphoric acids are sodium 2,2′-methylenebis(4,6-di-t-butylphenyl)phosphate (product name: ADEKASTAB [registered trade name] NA-11, manufactured by ADEAK Corporation), and aluminum salt of bis(2,4,8,10-tetra-t-butyl-6-hydroxy-12H-dibenzo[d,g][1,3,2]dioxaphosphocine-6-oxide)hydroxide (main component of product name: ADEKASTAB [registered trade name] NA-21, manufactured by ADEAK Corporation).

Examples of the dibenzylidene sorbitols are 1,3:2,4-di(p-methylbenzylidene) sorbitol, 1,3-o-methylbenzylidene-2,4-p-methylbenzylidene sorbitol, 1,3:2,4-di(benzylidene) sorbitol, 1,3:2,4-di(p-ethylbenzylidene) sorbitol, and 1,3:2,4-bis(3,4-dimethylbenzylidene) sorbitol, and preferred is 1,3:2,4-di(benzylidene) sorbitol from a viewpoint of odor.

Nucleating agents are usually particulate, and can be produced by a method known in the art, such as a grinding method, a crystallization method, and a combined method thereof. Particularly preferably used are nucleating agents having a weight average particle diameter of 0.01 to 10 μm, measured by a laser diffraction-type particle size distribution measurement method. When preparing nucleating agents by a grinding method, surface preparation agents may be contacted with them, in order to prevent aggregation among particles of the nucleating agents.

The nucleating agents are contained in an amount of 0.001 to 1 part by weight, preferably 0.01 to 1 part by weight, and further preferably 0.01 to 0.5 part by weight, per 100 parts by weight of the propylene block copolymer (A). When the amount is less than 0.001 part by weight, rigidity and impact resistance may be improved insufficiently, and when the amount is more than 1 part by weight, which amount is excess and simply uneconomical, impact resistance may be lowered.

In a production of the polypropylene resin composition of the present invention, the hindered amine light stabilizer (B) is effectively blended according to a method comprising the steps of, for example, melt-mixing the hindered amine light stabilizer (B) with the propylene block copolymer (A), thereby preparing a high-concentration mixture (referred to as a masterbatch) of the light stabilizer (B), which contains the hindered amine light stabilizer (B) in a concentration of 1 to 90% by weight, or homogeneously mixing the hindered amine light stabilizer (B) with one or more kinds of additives and/or polypropylene resin (for example, propylene block copolymer (A)), thereby preparing high-concentration granulated powders of the hindered amine light stabilizer (B), which contains the granular state-solidified hindered amine light stabilizer (B) in a concentration of 10 to 90% by weight, and then blending the high-concentration mixture or high-concentration granulated powders with the propylene block copolymer (A).

Also, the polypropylene resin composition of the present invention can be produced by blending and then melt-mixing the propylene block copolymer (A), the hindered amine light stabilizer (B), and optional additives and fillers. The melt-mixing is carried out according to, for example, a method known in the art, using a melt-mixing apparatus such as an extruder and a Banbury mixer.

Examples of the melt-mixing apparatus used for producing the polypropylene resin composition of the present invention are a uniaxial extruder, a biaxial extruder having the same rotation direction (ZSK [registered trade name] manufactured by Wernw Pfleideren, TEM [registered trade name] manufactured by Toshiba Machine Co., Ltd., and TEX [registered trade name] manufactured by The Japan Steel Works, Ltd.), and a biaxial extruder having the different rotation direction (CMP [registered trade name] and TEX [registered trade name] manufactured by The Japan Steel Works, Ltd., and FCM [registered trade name], NCM [registered trade name] and LCM [registered trade name] manufactured by Kobe Steel, Ltd.).

The polypropylene resin composition of the present invention has a shape such as strands, sheets, plates, and pellets obtained by cutting strands in a suitable length. In order to apply the polypropylene resin composition of the present invention to a molding process, the pellet length is preferably 1 to 50 mm, from a viewpoint of a production stability of obtained molded articles.

The polypropylene resin composition of the present invention can be molded by various kinds of molding methods, thereby obtaining molded articles, whose characteristics such as shape and size can be suitably determined.

Examples of a production method of the above molded articles are an injection molding method, a press molding method, a vacuum forming method, an expansion molding method, and an extrusion molding method, which methods are industrially used in general. There can also be exemplified a laminate molding method and a co-extrusion molding method, each of which methods laminates or co-extrudes, in accordance with an object, the polypropylene resin composition of the present invention with polyolefin resins or other resins similar to the polypropylene resin composition of the present invention in their kind.

The molded articles are preferably injection molded articles, and particularly preferably injection molded articles having 1 mm or more thickness. Examples of an injection molding method used for production thereof are a general injection molding method, an injection-expansion molding method, a supercritical injection-expansion molding method, an ultrafast injection molding method, an injection compression molding method, a gas-assist injection molding method, a sandwich molding method, and an insert-outsert molding method.

Examples of uses of the molded articles are automobile materials, home electric materials, building materials, bottles, containers, sheets, and films. The polypropylene resin composition of the present invention is preferably used for automobile interior materials, home electric materials, and building materials (particularly, products present in a living space of people), because of a little emission of VOC.

Examples of the automobile materials are interior parts such as a door trim, a pillar, an instrumental panel, a console box, a rocker panel, an arm rest, a door panel, and a spare tire cover; exterior parts such as a bumper, a spoiler, a fender, a sidestep; and other parts such as an air intake duct, a coolant reserve tank, a fender liner, a fan, and an under deflector. Further examples thereof are single-piece parts such as a front-end panel.

Examples of the home electric materials are materials for washing machines (outer tanks), materials for drying machines, materials for cleaners, materials for rice cookers, materials for pots, materials for warmers, materials for dishwashers, materials for air cleaners, materials for air conditioners, and materials for lightening apparatuses.

Further, examples of the building materials are indoor floor members, wall members and window frame members.

### EXAMPLE

The present invention is explained with the following Examples and Comparative Examples. Propylene block copolymers and additives used in Examples or Comparative Examples are shown below.

### (1) Propylene Block Copolymer (Component A)

Propylene block copolymers (A-1), (A-2), (A-3) and (A-4) were produced according to a liquid phase-gas phase polymerization method (multi-step polymerization method), using a catalyst obtained by a method disclosed in Example 5 of JP 7-216017A.

### Propylene Block Copolymer (A-1)

### Propylene-(Propylene-Ethylene) Block Copolymer

MFR (230° C.) thereof: 26 g/10 minutes

Ethylene unit content thereof: 7.0% by weight

Intrinsic viscosity ([η]Total) thereof: 1.4 dl/g

[η]_{II}/[η]_{I}=2.52

Polymer component (I): propylene homopolymer

Isotactic pentad fraction of polymer component (I): 0.983

Intrinsic viscosity of polymer component (I) [η]_{I}: 1.07 dl/g

Soluble part in xylene at 20° C. of polymer component (I) (CXS (I)): 0.2% by weight

Polymer component (II): propylene-ethylene copolymer

Content of polymer component (II): 20% by weight

Ethylene unit content of polymer component (II): 35% by weight

Intrinsic viscosity of polymer component (II) [η]_{II}: 2.7 dl/g

### Propylene Block Copolymer (A-2)

### Propylene-(Propylene-Ethylene) Block Copolymer

MFR thereof: 2.7 g/10 minutes

Ethylene unit content thereof: 6.8% by weight

Intrinsic viscosity ([η]Total) thereof: 2.0 dl/g

[η]_{II}/[η]_{I}=1.77

Polymer component (I): propylene homopolymer

Isotactic pentad fraction of polymer component (I): 0.980

Intrinsic viscosity of polymer component (I) [η]_{I}: 1.75 dl/g

Soluble part in xylene at 20° C. of polymer component (I) (CXS (I)): 0.3% by weight

Polymer component (II): propylene-ethylene copolymer

Content of polymer component (II): 18% by weight

Ethylene unit content of polymer component (II): 37% by weight

Intrinsic viscosity of polymer component (II) [η]_{II}: 3.1 dl/g

### Propylene Block Copolymer (A-3)

### Propylene-(Propylene-Ethylene) Block Copolymer

MFR thereof: 2.7 g/10 minutes

Ethylene unit content thereof: 6.7% by weight

Intrinsic viscosity ([η]Total) thereof: 2.1 dl/g

[η]_{II}/[η]_{I}=1.56

Polymer component (I): propylene homopolymer

Isotactic pentad fraction of polymer component (I): 0.980

Intrinsic viscosity of polymer component (I) [η]_{I}: 1.86 dl/g

Soluble part in xylene at 20° C. of polymer component (I) (CXS (I)): 0.3% by weight

Polymer component (II): propylene-ethylene copolymer

Content of polymer component (II): 24% by weight

Ethylene unit content of polymer component (II): 28% by weight

Intrinsic viscosity of polymer component (II) [η]_{I}: 2.9 dl/g

### Propylene Block Copolymer (A-4)

### Propylene-(Propylene-Ethylene) Block Copolymer

MFR thereof: 16 g/10 minutes

Ethylene unit content thereof: 9.1% by weight

Intrinsic viscosity ([η]Total) thereof: 1.81 dl/g

[η]_{II}/[η]_{I}=4.39

Polymer component (I): propylene homopolymer

Isotactic pentad fraction of polymer component (I): 0.983

Intrinsic viscosity of polymer component (I) [η]_{I}: 0.93 dl/g

Soluble part in xylene at 20° C. of polymer component (I) (CXS (I)): 0.25% by weight

Polymer component (II): propylene-ethylene copolymer

Content of polymer component (II): 27.9% by weight

Ethylene unit content of polymer component (II): 32.6% by weight

Intrinsic viscosity of polymer component (II) [η]_{II}: 4.08 dl/g

### (2) Light Stabilizer (Component (B))

### (B-1)

Product name: UVINUL [registered trade name] 5050H manufactured by BASF Japan Ltd.

Hindered amine oligomer “copolymer of N-(2,2,6,6-tetramethyl-4-piperidyl)maleic imide with C₂₀₋₂₄ α-olefin”

Structural Formula:

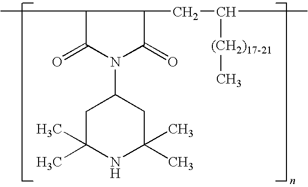

Molecular weight: 3,500

pKa: 7.0

Rate of weight loss by TG-DTA: 2.2%

### (B-2)

Product Name: ADEKASTAB LA52 Manufactured by ADEKA K.K.

Chemical name: tetrakis(1,2,2,6,6-pentamethyl-4-piperidyl) 1,2,3,4-buteane tetracarboxylate

Structural Formula:

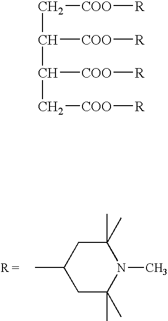

Molecular weight: 847

pKa: 8.9

Rate of weight loss by TG-DTA: 5.8%

### (B-3)

Product Name: TINUVIN 770DF Manufactured by Ciba Japan Inc.

Chemical name: bis(2,2,6,6-tetramethyl-4-piperidyl) sebacate

Structural Formula:

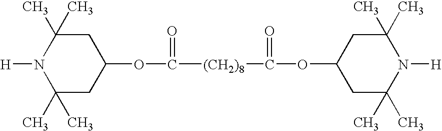

Molecular weight: 481

pKa: 9.0

Rate of weight loss by TG-DTA: 19.6%

### (B-4)

Product Name: TINUVIN [Registered Trade Name] 123 manufactured by Ciba Japan Inc.

Chemical name: bis(1-octyloxy-2,2,6,6-tetramethyl piperidin-4-yl) sebacate

Structural Formula:

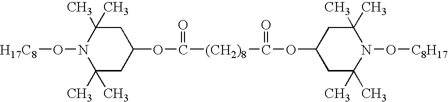

Molecular weight: 737

pKa: 4.4

Rate of weight loss by TG-DTA: 68.6%

### (B-5)

Product Name: CHIMASSORB [Registered Trade Name] 119FL manufactured by Ciba Japan Inc.

Chemical name: N,N-bis(3-aminopropyl)ethylenediamine. 2,4-bis[N-butyl-N-(1,2,2,6,6-pentamethyl-4-piperidyl)amino]-6-chloro-1,3,5-triazine condensate

Structural Formula:

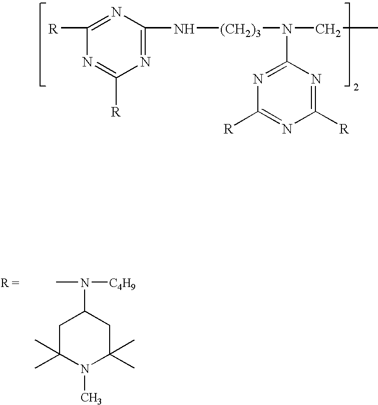

Molecular weight: 2,300

pKa: 9.2

Rate of weight loss by TG-DTA: 0.6%

### (B-6)

Product Name: SUMISORB [Registered Trade Name] 400 manufactured by Sumitomo Chemical Co., Ltd.

Chemical name: 2,4-di-t-butylphenyl-3,5-di-t-butyl-4-hydroxybenzoate

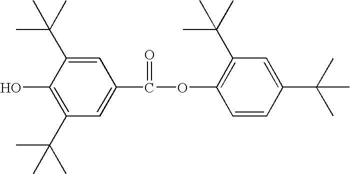

Molecular weight: 439

Rate of weight loss by TG-DTA: 31.6%

### (3) Additive (Component (C))

### (C-1) Calcium Stearate Manufactured by KYODO CHEMICAL CO., LTD.

(C-1H) Hydrotalcite DHT4C manufactured by Kyowa Chemical Industry Co., Ltd.

Chemical name: hydrotalcite

Chemical formula: Mg_{4.5}.Al₂(OH)₁₃ (CO₃)_{0.8}.O_{0.2}

### (C-2) Sumilizer [Registered Trade Name] GA80 Manufactured by Sumitomo Chemical Co., Ltd.

Chemical name: 3,9-bis[2-(3-(3-tert-butyl-4-hydroxy-5-methyphenyl)propionyloxy)-1,1-dimethylphenyl]-2,4,8,10-tetraoxaspiro[5.5]undecane

### (C-3) ADEKASTAB [Registered Trade Name] PEP-24G Manufactured by ADEKA K.K.

Chemical name: bis(2,4-di-tert-butylphenyl) pentaerythritol diphosphite

### (C-4) ELEC [Registered Trade Name] TS-5 Manufactured by Cao Corporation

Chemical name: stearic acid monoglyceride

### (4) Nucleating Agent (Component (D))

(D-1) PTBBA-AL manufactured by KYODO CHEMICAL CO., LTD.

Chemical name: aluminum hydroxyl-di(p-t-butylbenzoate)

Weight average particle diameter: 1.5 μm

### (D-2) Hyperform [Registered Trade Name] HPN-68L Manufactured by Milliken Japan K.K.

Chemical name: disodium=(1R,2R,3S,4S)-bicyclo[2.2.1] heptane-2,3-dicarboxylate (content: 80% by weight)

Weight average particle diameter: 1.8 μm

### (D-3) ADEKASTAB [Registered Trade Name] NA-11UY Manufactured by ADEKA K.K.

Chemical name: sodium 2,2′-methylenebis(4,6-di-t-butylphenyl)phosphate

Weight average particle diameter: 0.8 μm

### (D-4) Sodium Benzoate 20M Manufactured by Ciba Japan Inc.

Chemical name: sodium benzoate

Weight average particle diameter: 3.6 μm

### (5) Organic Peroxide (Component (E))

(E-1) 8% Masterbatch of PERKADOX [Registered Trade Name] 14 Manufactured by Kayaku Akzo Corporation, the Masterbatch being a Blend of 8% by Weight of an Organic Peroxide with 92% by Weight of Polypropylene Powder (Propylene Homopolymer)

Chemical name of the organic peroxide: 1,3-bis(t-butyl peroxyisopropyl)benzene

Properties and the like of the propylene block copolymer (component (A)) and polypropylene resin composition were measured according to the following test methods:

(1) Melt Flow Rate (MFR, Unit: g/10 minutes)

It was measured at 230° C. under a load of 2.16 kg according to JIS-K-6758.

(2) Intrinsic Viscosity ([η], Unit: dl/g)

It was measured according to a method comprising the steps of:
measuring respective reduced viscosities of TETRALINE solutions having concentrations of 0.1 g/dl, 0.2 g/dl and 0.5 g/dl, at 135° C. with an Ubbellohde viscometer; and
calculating an intrinsic viscosity according to a method described in “Kobunshi yoeki, Kobunshi jikkengaku 11” (published by Kyoritsu Shuppan Co. Ltd. in 1982), section 491, namely, by plotting those reduced viscosities for those concentrations, and then extrapolating the concentration to zero;
   wherein polymer powder collected from a polymerization reactor was used as those samples, and polymer powder collected from of the first step polymerization reactor was measured, thereby obtaining an intrinsic viscosity [η]_{I} of the polymer component (I).

### (3) Proportion of Polymer Components (I) and (II), and Measurement and Calculation of Intrinsic Viscosities [η]_{Total}, [η]_{I} and [η]_{II}

The intrinsic viscosity [η]_{II} of the polymer component (II) produced in the second step was obtained by calculating from the following formula:

[η]_{II}={[η]_{Total}−([η]_{I}×X_{I})}/X_{II}

wherein [η]_{Total} (dl/g) is an intrinsic viscosity of the finally obtained polymer; [η]_{I} (dl/g) is an intrinsic viscosity of polymer powders taken out of a polymerization reactor after the first polymerization step; X_{I} is a ratio by weight of the component produced in the first step; and X_{II} is a ratio by weight of the component produced in the second step; and X_{I} and X_{II} were obtained from a material balance in the polymerization.

### (4) Calculation of Content (% by Weight) of Propylene-Ethylene Copolymer Component (II) Contained in Propylene-(Propylene-Ethylene) Block Copolymer, and Content (% by Weight) of Ethylene Units Contained in Propylene-Ethylene Copolymer Component (II)

They were obtained from a ¹³C-NMR spectrum measured under the following conditions according to descriptions in Macromolecules, 15, 1150-1152 (1982) by Kakugo, et al., wherein a sample for the ¹³C-NMR measurement was prepared by dissolving homogeneously about 200 mg of the propylene-(propylene-ethylene) block copolymer in 3 mL of a mixed solvent (o-dichlorobenzene/deuterated o-dichlorobenzene-d=4/1 by volume) using a 10 mmΦ test tube:
apparatus: JNM-EX270 manufactured by JEOL DATUM LTD.,
measurement temperature: 135° C.,
pulse repetition time: 10 seconds,
flip angle: 45°, and
cumulated number: 2,500.

### (5) Emission Amount of VOC

It was measured according to a method comprising the steps of:

(i) encapsulating the test piece mentioned hereinafter in a 10 L-volume TEDLAR® bag;

(ii) replacing air in the TEDLAR® bag with pure nitrogen gas by filling it up with pure nitrogen gas and then gas purging, which operation was repeated two times in total;

(iii) filling it up with 4 liters of pure nitrogen gas, and closing a cock of the TEDLAR® bag;

(iv) placing the TEDLAR® bag in an oven, and attaching a Teflon-made sampling tube at the end of the cock, which tube was lengthened outside the oven;

(v) heating at 65° C. for two hours, thereby preparing a sample gas;

(vi) collecting 3 liters of the sample gas in a 2,4-dinitrophenylhydrazine (referred to as DNPH) cartridge under heating at 65° C.;

(v) subjecting the cartridge to a elution treatment, thereby obtaining an eluate;

(vi) analyzing the eluate with a high-speed liquid chromatograph (HPLC), thereby measuring components eluted from the cartridge, the components being VOC; and

(vii) calculating an emission amount of VOC using calibration curves of standard materials of the respective components, the emission amount being an amount [unit: μg] of VOC emitted from one test piece having a pre-determined size; wherein “not detectable (ND)” means detection of no VOC, and “<0.15” means detection of a smaller amount of VOC than a detection limit.

### (6) Light Stability

It was measured according to a method comprising the steps of:

(i) irradiating light in an intensity of 300 MJ or 600 MJ to a test piece under the following irradiation conditions, using a xenon weatherometer (type SX75AP) manufactured by Suga Test Instruments Co., Ltd., the test piece having a side of a holder of the xenon weatherometer (65 mm×150 mm×3 mm), and being prepared from an injection molded article having a size of 90 mm×150 mm×3 mm (thickness); and

(ii) evaluating existence or nonexistence of appearance abnormity on a surface of the test piece such as a crack, and a change of a gloss level of the test piece;
amount of light irradiated: 150 w/m² (region of 300 nm to 400 nm),
black panel temperature: 83° C.,
humidity in xenon weatherometer vessel: 50% RH
observation appearance abnormity such as crack: optical microscope (100 magnifications), and
measurement of gloss level: glossimeter (angle: 60°), wherein the higher the gloss retention rate is, the better the light stability is, and the gloss retention rate in the present invention being defined by the formula: (gloss level after irradiation/gloss level before irradiation)×100.

### (7) Heat Stability

It was measured according to a method comprising the steps of:

(i) putting 6 g of resin pellets in a cylinder of a melt indexer regulated at 280° C.;

(ii) keeping for 15 minutes under a load of an extruded rod, thereby melting the resin pellets, an outlet of an orifice of the melt indexer being sealed by a jig to prevent the molten resin from being extruded by the load through the orifice;

(iii) opening the orifice to extrude the molten resin quickly;

(iv) cooling the extruded resin to solidify the resin; and

(v) measuring MFR of the extruded resin, the MFR being referred to as “MFR after keeping”.

On the other hand, for comparison, there was measured MFR of resin pellets without the above keeping in a molten state, the MFR being referred to as “initial MFR”. The heat stability was evaluated by an MFR ratio defined by the ratio of “MFR after keeping” to “initial MFR”, MFR after keeping/initial MFR. In general, polypropylene resins decomposed by heating have a lager MFR than the initial MFR. Therefore, the smaller the MFR ratio is, the better the heat stability is.

### (8) Spiral Flow Length (SPF Length)

SPF length, which is an index of molding processability of polypropylene resin compositions, was measured according to a method comprising the steps of:

(i) injection molding under the following conditions; and

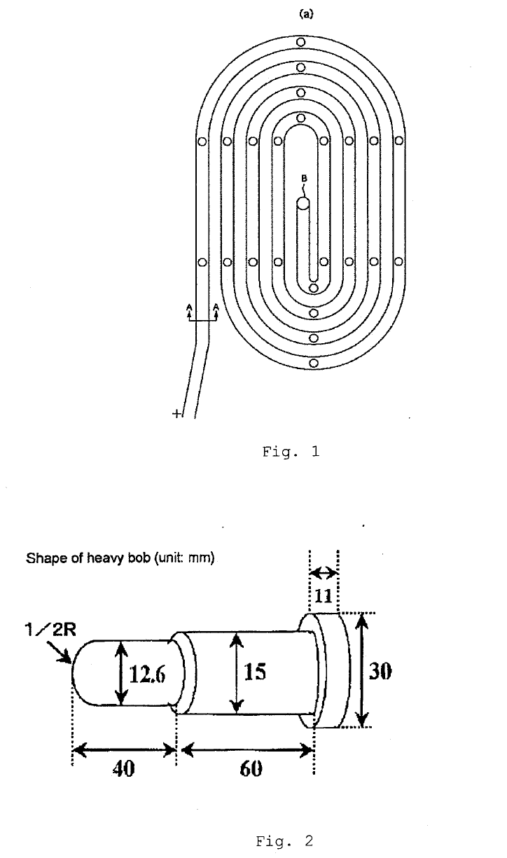

(ii) measuring SPF length, which is a length (mm) of a flow channel filled with a resin extruded under pre-determined conditions from a central part (B in FIG. 1) of a spiral mold as shown in FIG. 1, wherein the longer the SPF length is, the better the molding processability is;
molding machine: NEOMAT [registered trade name] type 350/120 injection molding machine manufactured by Sumitomo Heavy Industries, Ltd.,
molding temperature: 220° C.,
mold temperature: 50° C.,
mold: ellipsoidal spiral mold, its flow channel having a shape as shown in FIG. 1, and its cross-section A-A having a sized of 10 mm×2 mm,
injection time: 25 seconds,
cooling-down time: 9 seconds, and
injection pressure: 70 kgf/cm².

### (9) Mechanical Characteristics

1. Flexural Modulus (Rigidity, Unit: MPa)

It was measured according to JIS-K-7203 at 23° C. at a loading speed of 2.5 mm/minute, wherein an injection molded article having thickness of 6.4 mm and a span length of 100 mm was used as a test piece.

2. Falling Weight Impact Strength (Impact Resistance, Unit: J)

It was measured at −20° C. using as a test piece an injection molded article having a size of 150 mm (MD length)×90 mm (TD length)×3 mm (thickness), according to JIS K7211 except that a 5 kg-iron heavy bob having a shape as shown in FIG. 2 was used, thereby obtaining impact energy required for destroying half of all test pieces. The larger the impact energy is, the better the impact resistance is.

### (10) Preparation Method of Injection Molded Article

Test pieces for measuring the above emission amount of VOC, and test pieces (injection molded articles) for the above various evaluations were prepared according to the following method:

1. Molding Processing Method:

Injection mold was carried out at a molding temperature of 220° C. and at a mold cooling-down temperature of 50° C., using an injection molding machine NEOMAT [registered trade name] type 350/120 manufactured by Sumitomo Heavy Industries, Ltd.

2. Test Piece for Measuring Emission Amount of VOC:

According to molding processing conditions mentioned in the above item 1, there was obtained a molded article having a size of 150 mm (MD)×90 mm (TD)×3 mm (thickness). The molded article was cut up to obtain a test piece having one surface area of 80 cm². The test piece was allowed to stand at 23° C. for 14 days at 50% relative humidity, thereby obtaining a test piece for measurement.

3. Test Piece for Measuring Tensile Modulus:

According to molding processing conditions mentioned in the above item 1, there was obtained a molded article having thickness of 6.4 mm, which was used as a test piece.

4. Test Piece for Measuring Falling Weight Impact Strength:

According to molding processing conditions mentioned in the above item 1, there were obtained twenty molded articles having the same specifications as those of the molded article (before cutting up) for measuring VOC in the above item 2, which were used as test pieces.

5. Test Piece for Determining Molding Processability:

There was used a molded article having the same specifications as those of the molded article (before cutting up) for measuring VOC in the above item 2.

### Example 1

### Production of Propylene Block Copolymer (A-1)

### [Pre-Polymerization]

There were supplied degassed and dehydrated n-hexane, a solid catalyst component (A) produced according to a method disclosed in Example 5 of JP 7-216017A, cyclohexylethyldimethoxysilane (B), and triethylaluminum (C), to a stainless steel reactor equipped with a jacket, a quantitative ratio of (C) to (A) being 1.67 mmol/g, and a quantitative ratio of (B) to (C) being 0.13 mmol/mmol, thereby preparing a pre-polymerized catalyst component having a degree of propylene pre-polymerization of 3.5, wherein the degree of propylene pre-polymerization is defied as a gram amount of a pre-polymer produced per one gram of the solid catalyst component (A).

### [Main Polymerization]

### (I) First Polymerization Step (Production of Polymer Component (I))

### (I-1) Liquid Phase Polymerization

Gas contained in a stainless steel loop-typed liquid phase polymerization reactor was replaced completely with propylene. There were continuously supplied triethylaluminum (C), cyclohexylethyldimethoxysilane (B), and the above pre-polymerized catalyst component, to the polymerization reactor, a ratio of (B) to (C) being 0.15 mol/mol, and a supply rate of the pre-polymerized catalyst component being 2.2 g/hour. Then, an inside temperature of the polymerization reactor was raised to 70° C., and an inside pressure thereof was maintained at 4.5 MPa by continuously supplying propylene and hydrogen to the polymerization reactor, thereby initiating polymerization.

When a degree of polymerization reached 20% by weight of the total degree of polymerization, propylene homopolymer powder produced was taken out of the loop-typed liquid phase polymerization reactor, and was transferred to a stainless steel gas phase polymerization reactor, the gas phase polymerization reactor containing three vessels connected in series (first, second and third vessels), and the first vessel being connected to the above liquid phase polymerization reactor and the second vessel, and the second vessel being connected to the first and third vessels.

### (I-2) Gas Phase Polymerization

Propylene was homopolymerized continuously in the first and second vessels of the gas phase polymerization reactor. The gas phase polymerization in the first vessel was carried out continuously at 80° C. in the presence of the propylene homopolymer powder transferred from the above liquid phase polymerization reactor, under keeping a polymerization pressure at 2.1 MPa by supplying propylene continuously, and keeping a hydrogen concentration in the gas phase at 7.0% by volume by supplying hydrogen continuously, thereby forming a polymer component.

Then, a part of the polymer component was transferred intermittently to the second vessel, and the gas phase polymerization was continued at 80° C., under keeping a polymerization pressure at 1.7 MPa by supplying propylene continuously, and keeping a hydrogen concentration in the gas phase at 7.0% by volume by supplying hydrogen continuously, thereby forming a propylene homopolymer component (referred to hereinafter as polymer component (I)).

The polymer component (I) obtained in the second vessel was found by an analysis to have an intrinsic viscosity [η]_{I} of 1.07 dl/g, and an mmmm fraction of 0.983.

### (II) Second Polymerization Step (Production of Polymer Component (II))

A part of the polymer component (I) formed in the second vessel was transferred to the third vessel equipped with a jacket, and a production of a propylene-ethylene copolymer component (referred to hereinafter as polymer component (II)) was initiated by copolymerizing propylene with ethylene. The gas phase polymerization was continued at 70° C., under keeping a polymerization pressure at 1.3 MPa by supplying two parts by weight of propylene and one part by weight of ethylene continuously, and keeping a hydrogen concentration in the gas phase at 3.0% by volume by regulating the mixed gas concentration, thereby forming the polymer component (II).

Then, the powder contained in the third vessel was transferred intermittently to a deactivation vessel, in which catalyst components contained in the powder were deactivated with water. The resultant powder was dried with nitrogen of 65° C., thereby obtaining a white powdery propylene-(propylene-ethylene) block copolymer (referred to hereinafter as propylene block copolymer (A-1)).

The obtained propylene block copolymer was found to have an intrinsic viscosity ([η]_{Total}) of 1.4 d/g; an ethylene unit content of 7.0% by weight; and a polymerization ratio of the polymer component (I) to the polymer component (II) of 80/20. This ratio was calculated from an amount by weight of the finally-obtained propylene block copolymer and an amount of the polymer component (I). Therefore, the polymer component (II) was found to contain 35% by weight of ethylene units, and was found to have an intrinsic viscosity [η]_{II} of 2.7 d/g.

### [Pelletization (Melt Kneading and Filtration)]

There were mixed with one another 100 parts by weight of the obtained propylene block copolymer powder (A-1), 0.05 part by weight of the additives (C-1), (C-2) and (C-3), respectively, 0.3 part by weight of the additive (C-4), 0.1 part by weight of the nucleating agent (D-1), 0.1 part by weight of the light stabilizer (B-1), and 0.04 part by weight of the organic peroxide (E-1) (organic peroxide content: 8%), with a mixer, thereby preparing a mixture. Then, the mixture was melt kneaded using a uniaxial extruder (barrel inner diameter: 40 mm, screw rotating speed: 100 rpm, and cylinder temperature: 230° C.) manufactured by Tanabe Plastics Machinery Co., Ltd. The obtained melt kneaded product was filtered by a stainless steel filter (FINEPORE NF15N manufactured by Nippon Seisen Co., Ltd.) set up on a T die part of the uniaxial extruder, and was extruded through the T die. The extrudate was solidified by cooling it with cold water, and then was cut off, thereby obtaining pellets comprising the polypropylene resin composition. The extrusion capacity was 18 kg/hour.

### [Evaluation]

Performances of the above-obtained composition were evaluated, and their results are shown in Tables 1 and 3.

### Example 2

Example 1 was repeated except that 0.05 part by weight of the light stabilizer (B-6) was further mixed, thereby obtaining pellets comprising the polypropylene resin composition. Performances of the obtained composition were evaluated, and their results are shown in Table 1.

### Comparative Examples 1 to 4

Example 1 was repeated except that the light stabilizer (B-1) was change to the light stabilizer (B-2), (B-3), (B-4) or (B-5) in an amount as shown in Table 2, thereby obtaining pellets comprising the polypropylene resin composition. Performances of the obtained compositions were evaluated, and their results are shown in Table 2.

### Comparative Example 5

Example 1 was repeated except that the light stabilizer (B-1) was change to 0.1 part by weight of the light stabilizer (B-2), and 0.05 part by weight of the light stabilizer (B-6), thereby obtaining pellets comprising the polypropylene resin composition. Performances of the obtained composition were evaluated, and their results are shown in Table 2.

### Comparative Examples 6 and 7

Example 1 was repeated except that the propylene block copolymer (A-1) was changed to the propylene block copolymer (A-2) or (A-3), and the organic peroxide (E-1) was not used, thereby producing a polypropylene resin composition, wherein the propylene block copolymers (A-2) and (A-3) were produced according to the production method of the propylene block copolymer (A-1) described in Example 1, provided that their production conditions were changed so as to obtain the above-mentioned characteristic properties of the propylene block copolymers (A-2) and (A-3). Performances of the obtained polypropylene resin compositions were evaluated, and their results are shown in Table 3, wherein their test pieces for measuring an emission amount of VOC were found to have a flow mark by visual observation, and were found to have a warpage.

TABLE 1

| | | Example | | |
|---|---|---|---|---|
| | | 1 | 2 | |
| Composition | Component A | A-1 | A-1 | |
| | Part by weight | 100 | 100 | |
| | Component B | B-1 | B-1 | B-6 |
| | Part by weight | 0.10 | 0.10 | 0.05 |

| | | | |
|---|---|---|---|
| Flowability | Initial MFR | 31 | 31 |
| | (g/10 min.) | | |
| Heat stability | MFR after keeping | 42 | 44 |
| | (g/10 min.) | | |
| | MFR ratio | 1.4 | 1.4 |
| VOC | Formaldehyde (μg) | not detectable | not detectable |
| Light stability | Crack | none | none |
| Irradiation of | Gloss retention (%) | 95 | 95 |
| 300 MJ | | | |
| Light stability | Crack | none | none |
| Irradiation of | Gloss retention (%) | 92 | 92 |
| 600 MJ | | | |

“Common composition”
Component C: C-1 (0.05), C-2 (0.05), C-3 (0.05) and C-4 (0.3) (part by weight)
Component D: D-1 (0.1) (part by weight)
Component E: E-1 (0.04) (part by weight)

TABLE 2

| | | Comparative Example | | | | | |
|---|---|---|---|---|---|---|---|
| | | 1 | 2 | 3 | 4 | 5 | |
| Composition | Component A | A-1 | A-1 | A-1 | A-1 | A-1 | |
| | Part by weight | 100 | 100 | 100 | 100 | 100 | |
| | Component B | B-2 | B-3 | B-4 | B-5 | B-2 | B-6 |
| | Part by weight | 0.10 | 0.10 | 0.10 | 0.10 | 0.10 | 0.05 |

| | | | | | | |
|---|---|---|---|---|---|---|
| Flowability | Initial MFR (g/10 min.) | 30 | 31 | 29 | 30 | 31 |
| Heat stability | MFR after keeping (g/10 min.) | 39 | 43 | 46 | 39 | 40 |
| | MFR ratio | 1.3 | 1.4 | 1.6 | 1.3 | 1.3 |
| VOC | Formaldehyde (μg) | 1.2 | <0.15 | <0.15 | 0.93 | 3.1 |
| Light stability | Crack | none | none | none | none | none |
| Irradiation of 300 MJ | Gloss retention (%) | 87 | 89 | 89 | 71 | 94 |
| Light stability | Crack | none | none | none | none | none |
| Irradiation of 600 MJ | Gloss retention (%) | 82 | 89 | 83 | 86 | 85 |

“Common composition”
Component C: C-1 (0.05), C-2 (0.05), C-3 (0.05) and C-4 (0.3) (part by weight)
Component D: D-1 (0.1) (part by weight)
Component E: E-1 (0.04) (part by weight)

TABLE 3

| | | Example | Comparative Example | |
|---|---|---|---|---|
| | | 1 | 6 | 7 |
| Composition | Component A | A-1 | A-2 | A-3 |
| | Part by weight | 100 | 100 | 100 |
| | Component B | B-1 | B-1 | B-1 |
| | Part by weight | 0.10 | 0.10 | 0.10 |
| | Component E | E-1 | — | — |
| | Part by weight | 0.04 | | |
| VOC | Formaldehyde (μg) | not detectable | | |
| Flowability | Initial MFR | 31 | 3 | 3 |
| | (g/10 min.) | | | |
| Molding | SPF length (mm) | 840 | 430 | 380 |
| processability | Appearance | good | *1 | *1 |

*1 Flow mark and warpage were found.
“Common composition”
Component C: C-1 (0.05), C-2 (0.05), C-3 (0.05) and C-4 (0.3) (part by weight)
Component D: D-1 (0.1) (part by weight)

### Example 3

Example 1 was repeated except that the nucleating agent (D-1) was changed to 0.1 part by weight of the nucleating agent (D-2), and the organic peroxide (E-1) was not used, thereby obtaining pellets comprising the polypropylene resin composition. Performances of the obtained composition were evaluated, and their results are shown in Table 4.

### Example 4

### Production of Propylene Block Copolymer (A-4)

### [Pre-Polymerization]

There were supplied degassed and dehydrated n-hexane, a solid catalyst component (A) produced according to a method disclosed in Example 5 of JP 7-216017A, cyclohexylethyldimethoxysilane (B), and triethylaluminum (C), to a stainless steel reactor equipped with a jacket, a quantitative ratio of (C) to (A) being 6.0 mmol/g, and a quantitative ratio of (B) to (C) being 0.1 mmol/mmol, thereby preparing a pre-polymerized catalyst component having a degree of propylene pre-polymerization of 2.0, wherein the degree of propylene pre-polymerization is defied as a gram amount of a pre-polymer produced per one gram of the solid catalyst component (A).

### [Main Polymerization]

### Liquid Phase Polymerization

Gas contained in a stainless steel loop-typed liquid phase polymerization reactor was replaced completely with propylene. There were continuously supplied triethylaluminum (C), cyclohexylethyldimethoxysilane (B), and the above pre-polymerized catalyst component, to the polymerization reactor, a ratio of (B) to (C) being 0.145 mol/mol, and a supply rate of the pre-polymerized catalyst component being 1.671 g/hour. Then, an inside temperature of the polymerization reactor was raised to 70° C., and an inside pressure thereof was maintained at 4.5 MPa by continuously supplying 25 kg of propylene per hour and 215 NL of hydrogen per hour to the polymerization reactor, thereby initiating polymerization.

When a degree of polymerization reached 13.0% by weight of the total degree of polymerization, propylene homopolymer powder produced was taken out of the loop-typed liquid phase polymerization reactor, and was transferred to a stainless steel gas phase polymerization reactor, the gas phase polymerization reactor containing two vessels connected in series (first and second vessels), and the first vessel being connected to the above liquid phase polymerization reactor and the second vessel.

### Gas Phase Polymerization

The gas phase polymerization in the first vessel was carried out at 80° C. in the presence of the powdery propylene homopolymer component transferred from the above liquid phase polymerization reactor, under keeping a polymerization pressure at 1.8 MPa by supplying propylene continuously, and keeping a hydrogen concentration in the gas phase at 10.4% by volume by supplying hydrogen, thereby forming a propylene homopolymer component (referred to hereinafter as polymer component (I)).

The polymer component (I) obtained in the first vessel was found by an analysis to have an intrinsic viscosity [η]_{I} of 0.93 dl/g, an mmmm fraction of 0.983, and a content of a soluble part in xylene at 20° C. (CXS(I)) of 0.25% by weight.

Then, a part of the polymer component (I) formed in the first vessel was transferred to the second vessel, and a production of an ethylene-propylene copolymer component (referred to hereinafter as polymer component (II)) was initiated by copolymerizing propylene with ethylene. The gas phase polymerization was continued at 70° C., under keeping a polymerization pressure at 1.4 MPa by supplying continuously 2.34 parts by weight of propylene and one part by weight of ethylene, and keeping a hydrogen concentration in the gas phase at 0.79% by volume by regulating the mixed gas concentration, thereby forming the polymer component (II).

Next, the powder contained in the second vessel was transferred intermittently to a deactivation vessel, in which catalyst components contained in the powder were deactivated with water. The resultant powder was dried with nitrogen of 65° C., thereby obtaining a white powdery propylene-(propylene-ethylene) block copolymer (referred to hereinafter as propylene block copolymer (A-4)).

The obtained propylene block copolymer (A-4) was found to have an intrinsic viscosity [η]_{Total} of 1.81 d/g; an ethylene unit content of 9.1% by weight; and a ratio by weight of the polymer component (I) to the polymer component (II) of 72.1/27.9. This ratio was calculated from an amount by weight of the finally-obtained propylene block copolymer and an amount of the polymer component (I). Therefore, the polymer component (II) was found to contain 32.6% by weight of ethylene units, and was found to have an intrinsic viscosity [η]_{II} of 4.08 d/g.

### [Pelletization (Melt Kneading and Filtration)]

There were mixed with one another 100 parts by weight of the obtained propylene block copolymer powder (A-4), 0.1 part by weight of the light stabilizer (B-1), 0.05 part by weight of the additives (C-1), (C-2) and (C-3), respectively, 0.3 part by weight of the additive (C-4), and 0.1 part by weight of the nucleating agent (D-2), with a mixer, thereby preparing a mixture. Then, the mixture was melt kneaded using a uniaxial extruder (barrel inner diameter: 40 mm, screw rotating speed: 100 rpm, and cylinder temperature: 230° C.) manufactured by Tanabe Plastics Machinery Co., Ltd. The obtained melt kneaded product was filtered by a stainless steel filter (FINEPORE NF15N manufactured by Nippon Seisen Co., Ltd.) set up on a die part of the uniaxial extruder, and was extruded through the die. The extrudate was solidified by cooling it with cold water, and then was cut off, thereby obtaining pellets comprising the polypropylene resin composition. The extrusion capacity was 18 kg/hour.

### [Evaluation]

Performances of the above-obtained composition were evaluated, and their results are shown in Table 4.

### Comparative Example 8

Example 3 was repeated except that the propylene block copolymer (A-1) was changed to the propylene block copolymer (A-4), thereby producing a polypropylene resin composition. Performances of the obtained composition were evaluated, and results are shown in Table 4, wherein test pieces for measuring an emission amount of VOC were found to have a flow mark by visual observation, and were found to have a warpage. Evaluation results are shown in Table 4.

### Comparative Example 9

Comparative Example 8 was repeated except that 0.08 part by weight of the organic peroxide (E-1) (organic peroxide content: 8%) was further blended with 100 parts by weight of the propylene block copolymer (A-4), thereby producing a polypropylene resin composition. Performances of the obtained composition were evaluated, and results are shown in Table 4.

### Example 5

Example 3 was repeated except that the nucleating agent (D-2) was changed to 0.1 part by weight of the nucleating agent (D-1), thereby producing a polypropylene resin composition. Performances of the obtained composition were evaluated, and results are shown in Table 5.

### Example 6

Example 3 was repeated except that the nucleating agent (D-2) was changed to 0.1 part by weight of the nucleating agent (D-3), thereby producing a polypropylene resin composition. Performances of the obtained composition were evaluated, and results are shown in Table 5.

### Example 7

Example 3 was repeated except that the nucleating agent (D-2) was changed to 0.1 part by weight of the nucleating agent (D-4), thereby producing a polypropylene resin composition. Performances of the obtained composition were evaluated, and results are shown in Table 5.

### Example 8

Example 7 was repeated except that the additive (C-1) was changed to 0.05 part by weight of the additive (C-1H), thereby producing a polypropylene resin composition. Performances of the obtained composition were evaluated, and results are shown in Table 5.

TABLE 4

| | | Example | | Comparative Example | |
|---|---|---|---|---|---|
| | | 3 | 4 | 8 | 9 |
| Composition | Component A | A-1 | A-4 | A-2 | A-2 |
| | Part by weight | 100 | 100 | 100 | 100 |
| | Component B | B-1 | B-1 | B-1 | B-1 |
| | Part by weight | 0.10 | 0.10 | 0.10 | 0.10 |
| | Component E | — | — | — | E-1 |
| | Part by weight | — | — | — | 0.80 |
| Flowability | Initial MFR (g/10 min.) | 28 | 16 | 3 | 35 |
| Heat stability | MFR after keeping (g/10 min.) | 39 | 27 | 6 | 53 |
| | MFR ratio | 1.4 | 1.7 | 2.0 | 1.5 |
| VOC | Formaldehyde (μg) | not | not | not | not |
| | | detectable | detectable | detectable | detectable |
| | Acetaldehyde (μg) | <0.15 | 0.23 | 0.45 | 0.26 |
| Light stability | Crack | none | none | none | none |
| Irradiation of 300 MJ | Gloss retention (%) | 63 | 83 | 69 | 66 |
| Mechanical property | Flexural modulus (MPa) | 1,180 | 930 | 1,150 | 1,120 |
| | Falling ball impact strength (J) | 31 | 33 | 36 | 14 |
| Molding processability | SPF length (mm) | 810 | 700 | 470 | 750 |
| | Appearance | good | good | *1 | good |

*1 Flow mark and warpage were found.
“Common composition”
Component C: C-1 (0.05), C-2 (0.05), C-3 (0.05) and C-4 (0.3) (part by weight)
Component D: D-2 (0.1) (part by weight)

TABLE 5

| | | Example | | | |
|---|---|---|---|---|---|
| | | 5 | 6 | 7 | 8 |
| Composition | Component A | A-1 | A-4 | A-1 | A-1 |
| | Part by weight | 100 | 100 | 100 | 100 |
| | Component B | B-1 | B-1 | B-1 | B-1 |
| | Part by weight | 0.10 | 0.10 | 0.10 | 0.10 |
| | Component C | C-1 | C-1 | C-1 | C-1H |
| | Part by weight | 0.05 | 0.05 | 0.05 | 0.05 |
| | Component D | D-1 | D-3 | D-4 | D-4 |
| | Part by weight | 0.10 | 0.10 | 0.10 | 0.10 |
| Flowability | Initial MFR (g/10 min.) | 28 | 28 | 29 | 26 |
| Heat stability | MFR after keeping (g/10 min.) | 42 | 39 | 41 | 34 |
| | MFR ratio | 1.5 | 1.4 | 1.4 | 1.3 |
| VOC | Formaldehyde (μg) | not | not | not | not |
| | | detectable | detectable | detectable | detectable |
| | Acetaldehyde (μg) | <0.15 | <0.15 | 0.16 | <0.15 |
| Light stability | Crack | none | none | none | none |
| Irradiation of 300 MJ | Gloss retention (%) | 75 | 64 | 74 | 73 |
| Mechanical property | Flexural modulus (MPa) | 1,220 | 1,310 | 1,110 | 1,230 |
| | Falling ball impact strength (J) | 29 | 17 | 21 | 28 |
| Molding processability | SPF length (mm) | 810 | 820 | 810 | 810 |
| | Appearance | good | good | good | good |

“Common composition”
Component C: C-2 (0.05), C-3 (0.05) and C-4 (0.3) (part by weight)

Examples 1 and 2 detected no formaldehyde, and were good in their light stability and superior in their heat stability. Example 1 had such a long spiral flow length (SPF length) that it was superior in its molding processability.

Comparative Example 1, whose light stabilizer did not satisfy the requirements of the present invention, detected a large amount of formaldehyde.

Comparative Example 2 detected formaldehyde.

Comparative Example 3 detected formaldehyde.

Comparative Example 4 detected a large amount of formaldehyde.

Comparative Example 5 detected extremely a large amount of formaldehyde.

Comparative Examples 6 and 7 had such a short spiral flow length (SPF length), and such a bad appearance that they were poor in their processability.

Examples 3 and 4 detected no formaldehyde, and detected only a small amount of acetaldehyde. Examples 3 and 4 were so high in their flowability, and so long in their spiral flow length (SPF length) that they were superior in their molding processability. Further, Examples 3 and 4 were so high in their falling ball impact strength that they were superior in their impact resistance.

Comparative Example 8, whose propylene block copolymer did not satisfy the requirements of the present invention, detected a large amount of acetaldehyde. Further, Comparative Example 8 had such a short spiral flow length (SPF length), and such a bad appearance that it was poor in its processability. Comparative Example 9 was so low in its falling ball impact strength that it was poor in its impact resistance.

Examples 5 to 8 detected no formaldehyde, and detected only a small amount of acetaldehyde. Examples 5 to 8 were so high in their flowability, and so long in their spiral flow length (SPF length) that they were superior in their molding processability. Further, Examples 5 to 8 were so high in their falling ball impact strength that they were superior in their impact resistance. Examples 5, 6 and 8 were so high in their flexural modulus that they were superior in their mechanical property.

### INDUSTRIAL APPLICABILITY

According to the present invention, there can be obtained a polypropylene resin composition kind to environment, and a molded article comprising the same, the polypropylene resin composition being suppressed in its emission of VOC, and being superior in its heat stability, light stability and impact resistance as well as in its molding processability.

1. A polypropylene resin composition having a melt flow rate of 5 to 200 g/10 minutes measured at 230° C., which comprises:
100 parts by weight of a propylene block copolymer (A); and
0.05 to 5 parts by weight of a hindered amine light stabilizer (B) satisfying the following requirements (a), (b) and (c);
requirement (a) is that the hindered amine light stabilizer (B) has a 2,2,6,6-tetramethylpiperidyl group represented by the general formula (I), wherein X is linked to a carbon atom, an oxygen atom or a nitrogen atom, 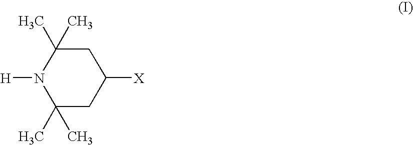
requirement (b) is that the hindered amine light stabilizer (B) has an acid dissociation constant (pKa) of less than 8, and
requirement (c) is that the hindered amine light stabilizer (B) shows a rate of decrease in its weight of less than 10% by heating in a nitrogen gas from 25° C. to 300° C. at a temperature increasing rate of 10° C./minute.

2. The polypropylene resin composition according to claim 1, wherein the hindered amine light stabilizer (B) satisfies also the following requirement (d)
requirement (d) is that the hindered amine light stabilizer (B) has a molecular weight of 1,000 or more.

3. The polypropylene resin composition according to claim 1, wherein the hindered amine light stabilizer (B) comprises a copolymer containing maleic imide derivative component represented by the general formula (II): 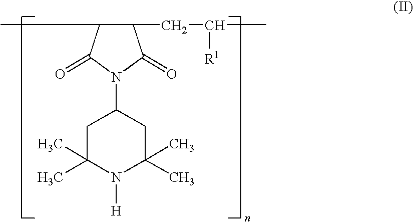
wherein R1 is an alkyl group having 10 to 30 carbon atoms; and n is an integer of larger than 1.

4. The polypropylene resin composition according to claim 1, wherein a phenol-type antioxidant having a molecular weight of 300 or more is also comprised in an amount of 0.01 to 1 part by weight per 100 parts by weight of the propylene block copolymer (A).

5. A molded article comprising the polypropylene resin composition according to claim 1.

6. A 1 mm or more-thick injection molded article comprising the polypropylene resin composition according to claim 1.
